(19) United States
(12) Patent Application Publication
(10) Pub. No.: US 2003/0105851 A1
(43) Pub. Date: Jun. 5, 2003

(54) Remote management unit with interface for remote data exchange

(75) Inventors: Michael Metzger, Nagold (DE); Thomas Dippon, Gaertringen (DE); Christian Hubert, Paderborn (DE)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/195,253

(22) Filed: Jul. 15, 2002

(30) Foreign Application Priority Data
Nov. 30, 2001 (EP) 01128559.0

(51) Int. Cl. G06F 15/173

(52) U.S. Cl. 709/223

(57) ABSTRACT

A remote management unit—RMU—manages a local data processing unit—DPU—from remote by a remote DPU. The RMU is coupled to the remote DPU by means of a network external with respect to the local DPU, and the RMU is coupled with the local DPU through an internal bus of the local DPU. The RMU comprises a data exchange interface for providing a data exchange between the local DPU and a remote data carrier coupled with the RMU through the external network. The data exchange interface is configured such that the local DPU regards the data exchange interface as representing or providing a standard interface of a data carrier type known by the local DPU. The data exchange interface is further configured to provide a data exchange of the RMU with the remote data carrier through the external network for executing the data exchange between the local DPU and the remote data carrier.

### BACKGROUND OF THE INVENTION

The present invention relates to Remote Management Units (RMUs) for remote managing a local data processing unit from a remote data processing unit.

An RMU is disclosed e.g. in EP-A-962862 by the same applicant. Amongst other applications, a memory of such RMU can be loaded from remote with data. The local DPU can then be configured in a way that it can access the RMU memory and e.g. download the stored data content. Such downloading from the RMU memory is in particular useful for providing a boot process of the local DPU from remote by the remote DPU.

### SUMMARY OF THE INVENTION

It is an object of the present invention to provide an improved remote management unit. The object is solved by the independent claims. Preferred embodiments are shown by the dependent claims.

According to the present invention, a remote management unit (RMU) is provided for managing a local data processing unit (DPU) from remote by a remote data processing unit. The RMU is coupled to or connected with the local DPU preferably by means of a local bus of the local DPU. The remote DPU is coupled to or connected with the RMU by means of an external network, such as LAN, WAN, etc., which might by wired or wireless.

The RMU comprises a data exchange interface for providing a data exchange between the local DPU and a remote data carrier (such as a server, memory, disc, dedicated storage devices, CDs, removable discs, etc.) connected with the RMU through the external network. The remote data carrier can be a unit independent of the remote DPU or a part thereof. In either case, the remote data carrier (RDC) preferably also comprises an individual RDC data exchange interface for independently executing data exchange through the external network.

For providing a data exchange between the local DPU and the remote data carrier, the data exchange interface (of the RMU) will be configured in a way that the local DPU regards the data exchange interface as representing or providing a standard interface of a data carrier type known by the local DPU. Such known data carrier type might be, for example, a SCSI disc, floppy disc, CD-ROM, IDE-disk, or similar data storage devices typically available in a computer environment. On the other side, the data exchange interface will further be configured to provide a data exchange of the RMU with the remote data carrier through the external network. The data exchange interface of the RMU is configured before providing the data exchange, preferably by the remote DPU, the remote data carrier, or the local DPU.

The network connection between RMU, remote DPU, and remote data carrier is not limited to a private network but can include the public Internet including routers, proxies, firewalls, etc.

Data content to be accessed by the local data processing unit will be preferably provided within the remote data carrier already having an appropriate data format corresponding to a data carrier format of the data carrier type as represented by the data exchange interface towards the local data processing unit. However, adequate data format conversion units for providing the required data format conversion might be applied accordingly, which might be accessed through the external network and can be part of the remote DPU or the RMU.

The invention thus provides an improved data exchange between the local DPU and the remote data carrier controlled by the remote DPU through the RMU. For applications such as rebooting the local DPU from the RMU, the invention thus overcomes limitations in local RMU memory space.

In order to facilitate the data exchange provided by the data exchange interface, the RMU might further comprise a local memory (preferably a cache memory) allowing temporarily buffering data. However, such local RMU memory is not necessary for executing the invention, and the data exchange interface can be configured for providing the data exchange between the remote data carrier and the local DPU without buffering or temporarily storing data.

The data exchange interface is thus capable of representing itself to the local DPU as standard data carrier type. This can be achieved by a combination of hardware and software components. In a similar fashion, the remote data carrier preferably already holds images of the corresponding data carrier type in its storage space. If, for instance, the data exchange interface represents itself as SCSI-disc with FAT file system, the file data image of the remote data carrier must be the file image of a SCSI based FAT file system. Those images can be easily generated using commercially available standard tools.

In a preferred embodiment, the role of the remote DPU is to properly configure the data exchange interface of the RMU and the data exchange interface of the remote data carrier. Configuration items may include the data format, whether or not the data represents a bootable image, the cache size, as well as security and login options. If in a particular system, for example, there is only one kind of data exchange interface and file system type implemented, this configuration process can also be omitted.

In a preferably embodiment, the RMU in conjunction with the remote data carrier ‘act’ as a bootable device for the local DPU, controlled by the remote DPU. The data format and content of the remote data carrier are provide adequate for the purpose of the local DPU, and the RMU is configured such that it presents itself as a bootable device to the local DPU. This can be achieved by flagging the data exchange interface as “bootable” device. This can be performed solely by adequate software tools and must follow the rules for bootable devices of the local DPU, for example hooking INT13 for INTEL based architectures.

It is clear that the invention can be partly or entirely embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawing.

FIG. 1 illustrates the invention using a generalized block diagram representation.

### DETAILED DESCRIPTION OF THE INVENTION

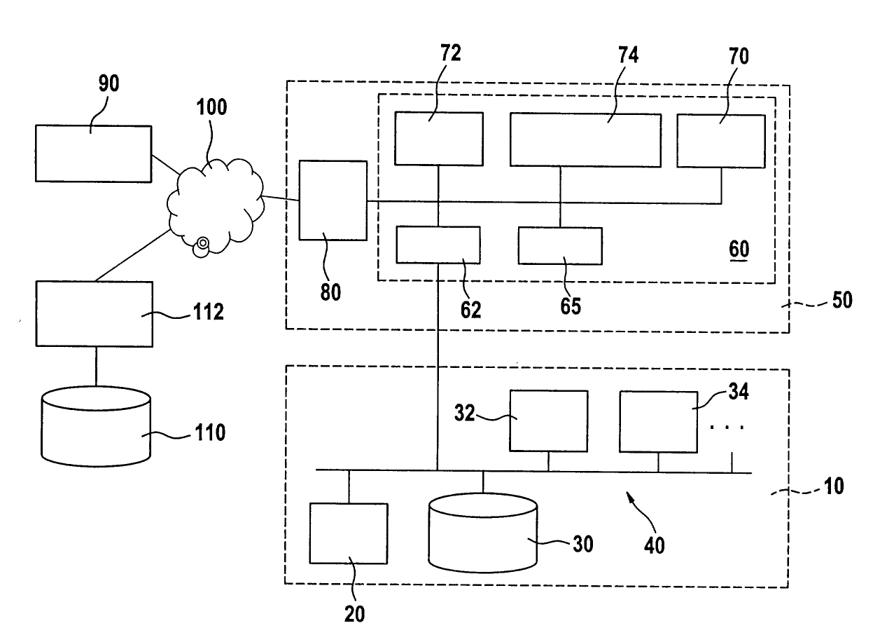

In FIG. 1, a local DPU 10 comprises a central processing unit (CPU) 20, a local memory 30, an OS Driver 32, and a BIOS 34, each connected to a local bus 40, such as a PCI bus, PCI-X, ISA, 3GI0, or any other bus system.

An RMU 50 comprises a data exchange interface 60 being provided by an interface 62, a CPU 65, an optional cache 70, a configuration data unit 72, a read/write request processing unit 74, and a network interface 80, each connected by an internal bus 90. The local DPU 10 and/or the RMU 50 might comprise further components, which, however, are omitted here for the sake of simplicity.

It is to be understood that FIG. 1 illustrates a logical representation with an assignment of features to either unit based on a logical separation of RMU- and DPU-functionalities. However, this does not necessarily mean or require physical separation of individual hardware or software components. For example, the interface 62 might be provided as hardware interface physically located within the local DPU 10. Features that would be part of the local DPU 10 without having the RMU 50 coupled are therefore ‘assigned’ to the local DPU 10 while features ‘added’ by coupling the RMU 50 are ‘assigned’ to the RMU 50.

The RMU 50 can be controlled by a remote DPU 90 connected with the RMU 50 by means of an external network 100, such as a LAN, WAN, etc. A remote data carrier 110 is also connected to the external network 100 or is part of the remote DPU 90. Similar to the RMU 50, the remote data carrier 100 comprises a RDC data exchange interface 112 representing the “counterpart” to the data exchange interface 60 of the RMU 50. Other components might be further connected to the external network 100 but are also omitted herein for the sake of simplicity.

In operation for providing a data exchange between the remote data carrier 110 and the local DPU 10 (which can be in either direction), the remote DPU 90 first configures the data exchange interface 60 by storing the network address of the remote DPU 90 and the remote data exchange interface 112 as well as other information pertinent to the data exchange (e.g. filename of the image) at the configuration unit 72. After configuration, the data exchange interface 60 will appear to the local DPU 10 as a standard interface for providing a data exchange with a data carrier type known to the local DPU 10. Such known data carrier type might be IDE, SCSI, CD-ROM, etc. In other words, after configuration the local DPU 10 will virtually “see” the data exchange interface 60 as such data carrier of the known type.

In case that data from the remote data carrier 110 is to be provided to the local DPU 10 or, in other words, in case the local DPU 10 wants to read from the ‘virtual’ data carrier represented by the data exchange interface 60 towards the local DPU 10, such data stored in the remote data carrier 110 have to provided in a data format corresponding to a data format of the virtual data carrier type. Alternatively, a data format conversion unit (not shown in the figures) might be provided in the external network 100 (or by the RMU 50 or the remote DPU 90) for correspondingly converting data formats.

After configuring the data exchange interface 60, a data exchange between the local DPU 10 and the remote data carrier 110 can be initiated. For reading from the remote data carrier 110, the local DPU 10 will read from the virtual data carrier represented by the data exchange interface 60, and the data exchange interface 60 itself will read correspondingly from the remote data carrier 110 through the external network 100.

Correspondingly, the local DPU 10 might want to store data to the virtual data carrier represented by the data exchange interface 60 and thus to the virtual data carrier 110. For that purpose, the local DPU 10 will send data in the adequate data format of the virtual data carrier to the data exchange interface 60, which will then store that data to the remote data carrier 110. In an example, read/write requests issued by the local DPU 10 are sent through the interface 62 to the RMU 50. The read/write processing unit 74 converts these requests into an appropriate network protocol and transmits them through the network interface 80 to the remote data carrier 110. As an example, for such a network protocol, the iSCSI protocol could be used. The remote data carrier 110 will unpack the read/write requests from the networking protocol and will execute the respective requests. For communication from the remote data carrier 110 back to the local DPU 10, the remote data carrier 110 will use the same technique as the RMU 50, namely embedding the requested data in the networking protocol. The read/write processing unit of the RMU 50 will then unpack the information delivered by the remote data carrier 110, convert it into the corresponding data format, if necessary, and present it to the local DPU 10 through the interface 62.

For performance reasons, the RMU 50 might use the optional cache 70 of variable size for buffering and/or caching data as well-known in the art.

The aforedescribed reading of the local DPU 10 from the remote data carrier 110 by means of the data exchange interface 60 of the RMU 50 is in particular useful for providing a boot operation of the local DPU 10 controlled by the remote DPU 90. For that purpose, the remote DPU 90 will first configure the local DPU 10 to “see” the data exchange interface 60 connected to the internal bus 40 of the local DPU 10 as an adequate bootable drive for executing a boot operation. For standard personal computer applications, such bootable drive types are normally a floppy disc (drive A:\), a hard disc, or a CD-ROM.

In accordance with the setting of the local DPU 10 for seeing such bootable drive in the data exchange interface 60, the remote DPU 90 will further configure the data exchange interface 60 in the aforedescribed manner in order to virtually provide such bootable drive towards the local DPU 10 and further to allow the data exchange interface 60 to access the remote data carrier 110. The remote DPU 90 will further provide adequate data content required for the boot operation in the data format of the virtual bootable drive to the remote data carrier 110, if not already contained therein.

In case that data contained in the remote data carrier 110 might not be in the expected data format, the remote DPU might further provide a data format conversion or instruct an adequate unit within the external network 100 (including the RMU 50) to provide such data format conversion. Thus, the remote DPU 90 can boot up the local DPU 10 from remote through the RMU 50 without requiring a direct interaction from side of the local DPU 10.

Alternatively or in addition to an executed boot operation, the remote DPU 90 can also efficiently load data to the local DPU 10 (e.g. to the local memory 30) through the RMU 50. This can be in particular advantageous for configuring the local DPU 10 from remote e.g. for installation of operating systems loading programs or other data to the local DPU 10.

1. A remote management unit—RMU—adapted for managing a local data processing unit—DPU—from remote by a remote DPU, the RMU being adapted to be coupled to the remote DPU by means of a network external with respect to the local DPU, and the RMU being coupled with the local DPU through an internal bus of the local DPU, the RMU comprising:
a data exchange interface for providing a data exchange between the local DPU and a remote data carrier coupled with the RMU through the external network,
wherein the data exchange interface is adapted to be configured:
(a) that the local DPU regards the data exchange interface as representing or providing a standard interface of a data carrier type known by the local DPU, and
(b) to provide a data exchange of the RMU with the remote data carrier through the external network for executing the data exchange between the local DPU and the remote data carrier.

2. The RMU of claim 1 being coupled to or connected with the local DPU by means of a local bus of the local DPU.

3. The RMU of claim 1, further comprising a local memory for temporarily buffering and/or caching data.

4. A system for providing a data exchange between a local data processing unit—DPU—and a remote data carrier, comprising:
a remote DPU,
a remote management unit—RMU—according to claim 1, being coupled to the local DPU and adapted for managing the local DPU from remote by the remote DPU and for providing the data exchange between the local DPU and the remote data carrier,
wherein the remote DPU, the remote data carrier, and the RMU are coupled through a network external with respect to the local DPU, and the RMU is coupled with the local DPU through an internal bus of the local DPU.

5. A method for providing a data exchange between a local data processing unit—DPU—and a remote data carrier in a system comprising a remote management unit—RMU—coupled to the local DPU and adapted for managing the local DPU from remote by a remote DPU, wherein the remote DPU, the remote data carrier, and the RMU are coupled through an external network, the method comprising the steps of:
(a) configuring a data exchange interface of the RMU in a way that the local DPU regards the data exchange interface as representing or providing a standard interface of a data carrier type known by the local DPU,
(b) providing a data exchange of the RMU with the remote data carrier through the external network for executing the data exchange between the local DPU and the remote data carrier.

6. The method of claim 5, wherein step comprises the steps of:
providing a data exchange between the local DPU and the data exchange interface in accordance with a virtual data exchange between the local DPU and a data carrier of the type as represented by the data exchange interface towards the local DPU, and
providing a data exchange between the data exchange interface and the remote data carrier through the external network.

7. The method of claim 5, wherein step is executed by the remote DPU.

8. The method of claim 5, further comprising a step of providing a data content to be accessed for the local DPU in the remote data carrier, the data content having an appropriate data format corresponding to a data carrier format of the data carrier type as represented by the data exchange interface towards the local DPU.

9. The method of claim 8, wherein the data content in the appropriate data format is provided in the remote data carrier before being accessed from the RMU, or wherein a data format conversion of the data content into the appropriate data format is provided after being accessed from the RMU.

10. A method for loading a data content to a local data processing unit—DPU—by means of a remote management unit—RMU—controlled from remote by a remote DPU, the method comprising the steps of:
(a) configuring—through a network external with respect to the local DPU—a data exchange interface of the RMU in a way that the local DPU regards the data exchange interface as representing or providing a standard interface of a virtual data carrier of a type known by the local DPU, and
(b) initiating the local DPU to virtually read the data content from the virtual data carrier as represented by the data exchange interface to the local DPU, whereby the data exchange interface requests and receives the data content from a remote data carrier through the external network and provides the received data content to the local DPU in a data format corresponding to a data format of the virtual data carrier.

11. The method of claim 10, further comprising a step of providing the data content to the remote data carrier.

12. A method for booting a local data processing unit—DPU—from remote by a remote DPU, the method comprising the steps of:
(a) configuring a data exchange interface of a remote management unit—RMU—in a way that the local DPU regards the data exchange interface as representing or providing a standard bootable drive of a virtual data carrier of a type known by the local DPU, the RMU being coupled with the remote DPU through a network external with respect to the local DPU, and the RMU being coupled with the local DPU through an internal bus of the local DPU,
(b) initiating the local DPU to virtually boot from the virtual data carrier as represented by the data exchange interface to the local DPU, whereby the data exchange interface requests and receives data content requested by the local DPU from a remote data carrier through the external network and provides the received data content to the local DPU in a data format corresponding to a data format of the virtual data carrier.

13. A software program or product, preferably stored on a data carrier, for executing the method of claim 5, when run on a data processing system such as a computer.
